(19) United States
(12) Patent Application Publication
(10) Pub. No.: US 2010/0263576 A1
(43) Pub. Date: Oct. 21, 2010

(54) AGGREGATED PARTICULATE MINERALS, COMPOSITIONS COMPRISING AGGREGATED CALCIUM CARBONATE, METHODS OF MAKING AND USES THEREOF

(75) Inventors: Edward J. Sare, Macon, GA (US); Stephen C. Raper, Byron, GA (US); Julie Figlar, Clemmons, NC (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Kaolin, Inc.

(21) Appl. No.: 12/781,980

(22) Filed: May 18, 2010

Related U.S. Application Data
(62) Division of application No. 11/910,265, filed on Sep. 29, 2007.
(60) Provisional application No. 60/666,558, filed on Mar. 31, 2005.
(60) Provisional application No. 60/678,794, filed on May 9, 2005.

(51) Int. Cl. C09C 1/02; C08K 3/26

(52) U.S. Cl. 106/464; 524/426; 524/427

(57) ABSTRACT

Disclosed herein are dry aggregated calcium carbonates, comprising calcium carbonate and at least one inorganic binder, wherein the dry aggregated calcium carbonate has a median aggregate particle size (D50) of at least 5 microns. Also disclosed are compositions comprising such calcium carbonates. Products, such as paints, and methods of making products containing such aggregated calcium carbonate are further disclosed.

This application claims priority to U.S. Provisional Patent Application No. 60/666,558, filed Mar. 31, 2005, and U.S. Provisional Patent Application No. 60/678,794, filed May 9, 2005.

Disclosed herein are dry aggregated calcium carbonates, comprising at least one calcium carbonate and at least one inorganic binder. Also disclosed herein are compositions comprising at least one aggregated calcium carbonate. Methods of making such aggregated calcium carbonates and products, such as paints, comprising such aggregated calcium carbonates are further disclosed.

Particulate minerals, such as calcium carbonate, have been widely used as property enhancing pigments or fillers in various products, such as paints, paper, paper coatings, adhesives, caulks, sealants, plastic compositions, and film laminates.

The present inventors have surprisingly discovered that dry aggregated calcium carbonate with a median aggregate particle size (D50) of at least 5 μm can be obtained using an inorganic binder. The dry aggregated calcium carbonate disclosed herein can provide beneficial properties to a final product, such as provide good optical properties to a tinted system. For example, the dry aggregated calcium carbonate can be used to provide low sheen and high opacity properties to paints, such as architectural or decorative textured paints.

Optical properties are often used to assess PVC tinted systems, such as dry paint films. One property is the opacity (or “hide”) of the dry paint film. Another property is the sheen of the dry paint film. In addition, “tint strength” is a measure of the overall color response to the addition of colorants. Tinted films have been growing in popularity over white paints, such as in the case of the architectural or decorative paint market.

“Tinted systems” refer to any colorable media, such as paints, inks, colorable sealants, colorable caulks, grout, synthetic stucco, block filler (a very high PVC paint used to coat concrete block and similar surfaces), and plastics. “PVC” means “pigment volume concentration” and is defined according to the following equation:

$$PVC = \frac{volume of pigments}{volume of pigments + volume of binder}$$

### BRIEF DESCRIPTION OF THE DRAWINGS

The following drawings, which form part of the disclosure, depict additional aspects of the disclosure.

FIG. 1 shows a Scanning Electron Microscopy (SEM) micrograph of a commercially available GCC product before aggregating using the method disclosed herein.

FIG. 2 shows a SEM micrograph of an aggregated calcium carbonate made from the same commercially available GCC product using the method disclosed herein and at the same resolution as in FIG. 1.

FIG. 3 shows particle size distributions of a control and aggregated calcium carbonates made in accordance with the present disclosure.

FIG. 4 shows a comparison of the sheen and opacity of a 45% PVC dry paint films made using several control calcium carbonates and several aggregated calcium carbonates made in accordance with the present disclosure.

In one aspect, the present disclosure relates to a dry aggregated calcium carbonate comprising at least one inorganic binder, wherein the aggregated calcium carbonate has a median aggregate particle size (D50) of at least 5 μm.

In certain embodiments, the resulting aggregate may also include the chemical reaction products between the starting materials, such as calcium carbonate and the inorganic binder. For example, it may be possible to form silica gel if, for example, sodium silicate is used in a CO₂ containing atmosphere or under acidic conditions. The formation of silica gel may assist in holding the aggregated calcium carbonate together, for example, from the formation of calcium silicate.

Calcium carbonate encompasses both ground calcium carbonate (GCC) and precipitated calcium carbonate (PCC). PCC is generally prepared by a process in which calcium carbonate is calcined to produce calcium oxide, or “quicklime,” the quicklime then is “slaked” with water to produce an aqueous slurry of calcium hydroxide, and finally, the calcium hydroxide is carbonated with a carbon-dioxide-containing gas to produce PCC. GCC may comprise ground naturally occurring calcium carbonate from sources such as marble, limestone, dolomite and chalk. PCC may also be ground.

The calcium carbonate for making the aggregates (i.e., feed particulate mineral) as disclosed herein may have a median particle size (D50) of, for example, less than 5 μm, such as less than 3 μm, or even such as less than 1 μm.

The dry aggregated calcium carbonate as disclosed herein has a median aggregate particle size (D50) of at least 5 μm, such as at least 7 μm, further such as at least 10 μm, even further such as at least 12 μm. In one embodiment, the dry aggregated calcium carbonate has a median aggregate particle size (D50) of at least 15 μm, such as at least 20 μm, further such as at least 50 μm, even further such as at least 70 μm, and yet even further such as at least 100 μm. As used herein, the term “aggregated” (or versions thereof) refers to a material, such as calcium carbonate, that takes at least a mortar and pestle to break up, and that survives spray drying.

The median particle size (D50) and the median aggregate particle size (D50) can be determined by, for example, a standard test procedure employing Stokes' Law of Sedimentation. For example, the median aggregate particle size of the aggregated calcium carbonate can be determined by measuring the sedimentation of the particulate product in a fully dispersed condition in a standard aqueous medium, such as water, using a SEDIGRAPH™ instrument, e.g., SEDIGRAPH 5100, obtained from Micromeritics Corporation, USA.

The inorganic binder as disclosed herein is chosen, for example, from silicates, phosphates, borates, tungstates, aluminates, boric acid, and other polyvalent metal salts, such as those that form inorganic polymers. Phosphoric acid may also be used as the inorganic binder. As used herein, the term “silicate” means any water soluble silicate and is defined as a salt derived from silica or the silicic acids. In one embodiment, the at least one inorganic binder is chosen from alkali metal silicates, such as sodium silicate.

Further disclosed herein are compositions comprising dry aggregated calcium carbonate as discussed above.

In another aspect, the present disclosure relates to a method of making a dry aggregated calcium carbonate. In one embodiment, the method comprises:

slurrying calcium carbonate having a median particle size (D50) of less than 1 μm;

including at least one inorganic binder into the calcium carbonate slurry; and

at least partially dewatering the resulting slurry so that the resulting dry aggregated calcium carbonate has a median aggregate particle size (D50) of at least 5 μm.

As used herein, the term “dry” means less than about 30% by weight of water, such as less than about 20%, less than about 10%, less than about 5%, or even less than about 2% by weight of water. In one embodiment, the dry aggregated calcium carbonate has less than about 1% by weight of water.

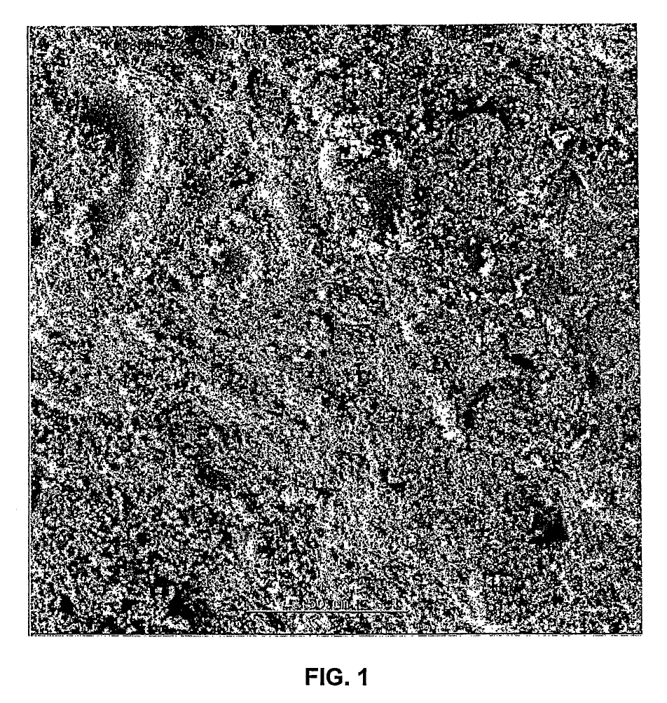

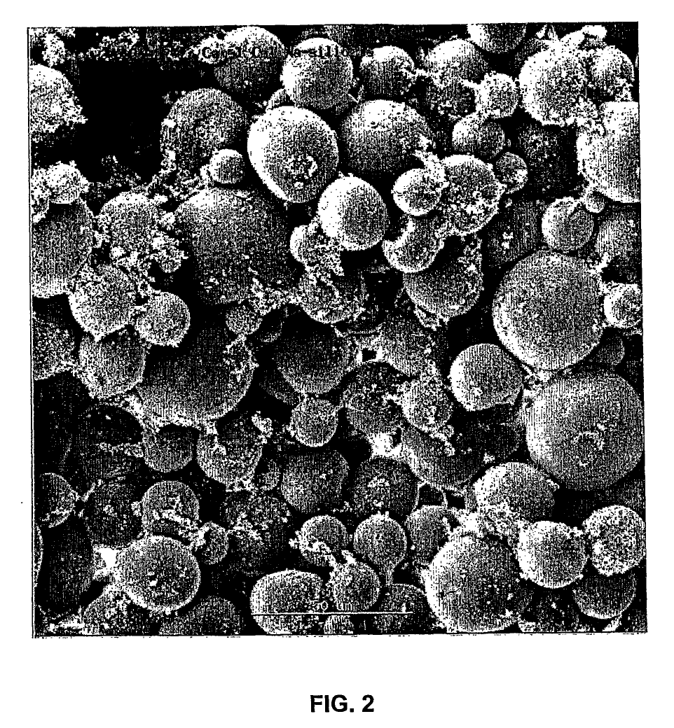

As used herein, the term “slurry” means a dispersion of finely divided solid particles in a liquid medium, typically an aqueous medium such as water. The particulate minerals used in the method disclosed herein as feed particulate minerals are fine particles, having a median particle size, for example, of less than 1 μm. One exemplary embodiment is shown in FIG. 1, i.e., a Scanning Electron Microscopy (SEM) micrograph of a commercially available GCC product with a median particle size of less than 1 μm before aggregating using the method disclosed herein. In comparison, at the same resolution as in FIG. 1 and using the same commercially available GCC product, FIG. 2 shows a SEM micrograph of an aggregated calcium carbonate made from the GCC product using sodium silicate as the inorganic binder and the method as disclosed herein. The aggregated calcium carbonate shown in FIG. 2 has a median aggregate particle size (D50) of greater than 10 μm.

The dewatering may be accomplished by techniques commonly known to one of ordinary skill in the art, such as an evaporative dewatering or thermal dewatering. In one embodiment, thermal dewatering and aggregation is accomplished by heating the aggregated calcium carbonate in an oven or kiln.

In another embodiment, evaporative dewatering is accomplished by spray drying. The apparatus and process for spray drying are known to one of ordinary skill in the art. For example, the spray drying disclosed herein can be operated using the apparatus and process disclosed in U.S. Pat. Nos. 4,642,904 and 5,248,387, which are incorporated herein by reference. In addition, spray driers of various designs can be used, which may be of concurrent, countercurrent, or mixed flow type. Nozzles, disks or similar dispersing parts can be used to disperse the slurry into droplets. The temperature of the inlet and outlet air of the spray dryer depends on the design of the spray dryer. During the spray drying, the slurry, comprising calcium carbonate, an inorganic binder, and water, is heated to at least 95° C., such as for example to at least 120° C. In one embodiment, the evaporative dewatering is accomplished by spray drying as described above, in the presence of a carbon dioxide enriched atmosphere. In another embodiment, the evaporative dewatering is accomplished by spray drying in an acidic atmosphere.

Further disclosed herein are products, such as paints, further such as textured paints, comprising the dry aggregated calcium carbonate as disclosed herein. The products as disclosed herein can have good optical properties, such as dry paint films having a low sheen and high opacity.

In addition, tint strength can be related to the magnitude of ΔE, which is defined below:

ΔE=(ΔL²+Δa²+Δb²)^{1/2}

Components a, b, and L are the color component values on the color space scale and can be measured by a Hunter Ultrascan XE instrument. “+a” is a measure of red tint; “−a” is a measure of green tint; “+b” is a measure of yellow tint; “®-b” is a measure of blue tint; “L” is a measure of whiteness. Whiteness can be measured by the ASTM-E-313 standard method.

It can be appreciated that the relative color of the paint can be “lighter” (e.g., less blue) or “darker” (e.g., more blue). In the case of tint strength, the “lighter” colored paint is considered to have the higher tint strength after addition of a darker pigment.

Another optical property of the dry paint film is 457 brightness, which can be measured using a standard method, such as for example using ASTM D 985-97 (directional reflectance at 457 nm).

Yet another optical property of the dry paint film is opacity. Paint film opacity is related to light scattering, which may occur when light travels through two or more different materials, as different materials typically have different refractive indices. In a pigmented paint, light can be scattered by both the pigment and extender, as well as cavities or voids. Thus, to maximize opacity, it is generally desired to maximize light scattering by the pigment/extender and voids or cavities.

The paint as disclosed herein may also comprise at least one additive chosen from conventional additives, such as pigments other than the aggregated calcium carbonate disclosed herein, surfactants, thickeners, defoamers, wetting agents, dispersants, solvents, and coalescents. Exemplary paints include textured paints, latex paints, oil-based paints, and acrylic paints.

In one embodiment, the paint as disclosed herein may have a pigment volume concentration (PVC) ranging, for example, from about 25% to about 85%, such as from about 40% to about 70%, such as from about 40% to about 50%, further such as from about 50% to about 60%, and even further such as from about 60% to about 70%. In another embodiment, the paint has a pigment volume concentration of at least about 70%, such as ranging from about 70% to about 85%.

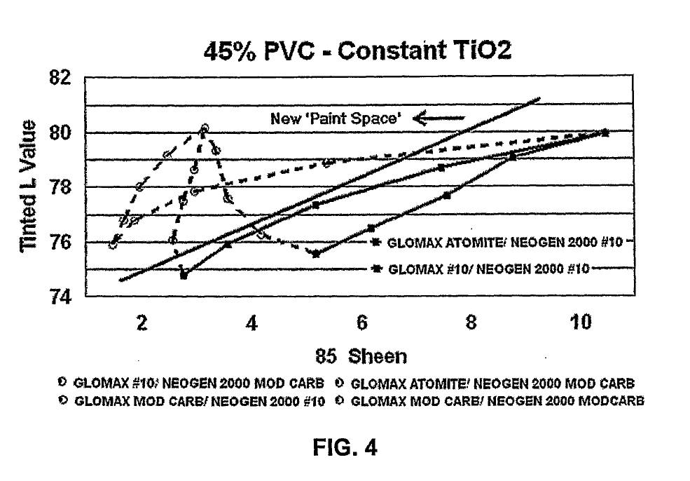

Due to the inverse relationship between sheen and opacity, it has previously not been possible to produce paints having a high opacity and low sheen, without using flatting agent such as diatomaceous earth or flux calcined diatomaceous earth. Accordingly, traditional paints generally have a trade-off in opacity and sheen characteristics, or require the use a flatting agent. The present disclosure allows for previously unachievable combinations of low sheen and high opacity without the use of flatting agents. These properties can be seen graphically on FIG. 4 as being left of the curve for the control sample.

Accordingly, in various embodiments of the present disclosure, there are disclosed paints with high opacity and low sheen, comprising dry aggregated calcium carbonate and at least one inorganic binder, as discussed above, wherein the dry paint film made from the paint has a sheen of less than 8 and opacity of at least 92. In one embodiment, the dry paint film made from the paint disclosed herein meets the following relationship:

Op≧(0.88s)+Y₁

wherein Op=opacity, s=sheen, and Y=92.

For example, the dry paint film made from the paint disclosed herein may have opacity of greater than 94, and sheen of less than 3. Further, for example, the dry paint film may have opacity of greater than 95, and sheen of less than 4. Even further, for example, the dry paint film may have opacity of greater than 96, and sheen of less than 5. In one embodiment, the dry paint film has opacity of greater than 97, and sheen of less than 6. In an embodiment, the dry paint film can have a PVC ranging from 40% to 50%, such as for example about 45%.

In other embodiments, Y may be 93, 94, or 95.

In another aspect, disclosed herein is a polymer product comprising the aggregated calcium carbonates disclosed herein. The aggregated calcium carbonates disclosed herein can be used for resin extension (i.e., filling), TiO₂ extension, and reinforcement of the polymer. In one aspect, the polymer product can be a highly filled polymer such as a cultured marble. In another aspect, the polymer product can be a plastic. In yet another aspect, the polymer product can be an adhesive, caulk or sealant.

The polymer product disclosed herein comprises at least one polymer resin. The term “resin” means a polymeric material, either solid or liquid, prior to shaping into a plastic article. The at least one polymer resin can be one which, on cooling (in the case of thermoplastic plastics) or curing (in the case of thermosetting plastics), can form a plastic material.

The at least one polymer resin, which can be used herein, can be chosen, for example, from polyolefin resins, polyamide resins, polyester resins, engineering polymers, allyl resins, thermoplastic resins, and thermoset resins.

In another aspect, the present disclosure provides a rubber product comprising the aggregated calcium carbonates disclosed herein. The products can provide the benefits of resin extension, reinforcement of the rubber, and increased hardness of the rubber composition. The rubber product disclosed herein comprises at least one rubber chosen from natural rubbers and synthetic rubbers.

In another aspect, the present disclosure provides a coating or filler for paper or paperboard comprising the aggregated calcium carbonate disclosed herein. Another aspect provides a method of making a barrier coating from the aggregated calcium carbonates having the properties described herein. Barrier coatings are useful to impart paper resistance to moisture, moisture vapor, grease, oil, air, etc. When making barrier coatings, the amount of binder in the formulation may be high on the order of 40% to 50%.

Another aspect of the present disclosure provides an aggregated calcium carbonate for use in catalyst applications, such as automotive catalytic converters or in catalytic cracking applications.

In yet another aspect, the present invention provides a feed for a ceramic, wherein the feed comprises the aggregated calcium carbonate as described herein. The ceramic can be used for supporting a catalyst, such as a catalyst used in a catalytic converter. In another embodiment, the ceramic comprises the catalyst.

The present disclosure is further illustrated by the following non-limiting examples, which are intended to be purely exemplary of the invention. In the examples shown below, the following abbreviations are used:

#=number of pounds of the inorganic binder that were added per ton of calcium carbonate on a dry weight basis,

AM Borate=Ammonium borate,

NaBorate=Sodium borate, and

NaSil=Sodium silicate.

### EXAMPLES

### Example 1

### Preparation of Aggregated Calcium Carbonate

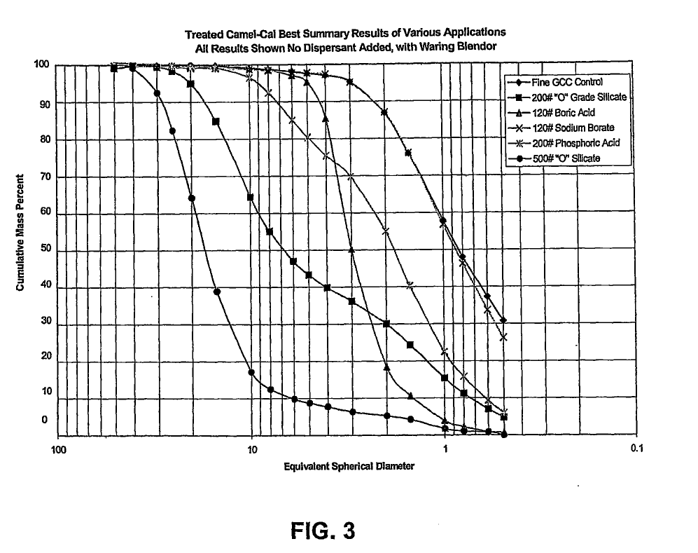

In this example, a commercially available ground calcium carbonate having a median particle size (D50) of about 0.8 μm was used. The ground calcium carbonate was slurried in water to 37% solids content and an appropriate amount of the inorganic binder was added and mixed therewith as shown in the legend of FIG. 3. At this point, the only components in the samples were water, calcium carbonate, and the inorganic binder. The mixture was then screened through a 325 mesh screen, and then spray dried using a conventional process at 400° C., which was sufficient to raise the temperature of the mixture to approximately 130° C. The spray dryer used was a NercoNiro model-IV circa, 1963, from Nichols Engineering.

In the spray dryer, the slurry was atomized and dried by exposure to heated gases. The resultant dry product was then withdrawn from the spay dryer in two discrete fractions: beads and dust. The beads including the aggregated calcium carbonate were retained as samples.

The retained samples were dispersed using a Waring blender prior to the measurement of the particle size distribution. No chemical dispersants were added. The particle size distribution for the retained aggregated calcium carbonate samples in this example is illustrated in FIG. 3, which shows a graph of equivalent spherical diameter (μm, x-axis), as measured by a Sedigraph 5100, versus cumulative mass percent (y-axis).

In the legend of FIG. 3, the term “Fine GCC Control” refers to the control, i.e., the commercially available ground calcium carbonate having a nominal median particle size of about 0.7 μm, which was subject to the slurrying and spray drying operations as discussed above, but without addition of any inorganic binder. Further, the term “O′ Grade Silicate” or “O′ Silicate” refers to “O” Grade sodium silicate, wherein the alkali metal content ranges from 8.95% to 9.35% by weight, and SiO₂ content ranges from 28.82% to 30.11% by weight.

As shown in FIG. 3, the addition of 500 pounds of the “O” Grade sodium silicate per ton of the ground calcium carbonate on a dry weight basis as the inorganic binder led to the best results of the aggregated calcium carbonate among various other types of the inorganic binders and in comparison with the control. In addition, beneficial results were also obtained using 200 pounds of the “O” Grade sodium silicate per ton of the ground calcium carbonate on a dry weight basis as the inorganic binder.

It is noted that in FIG. 3 that the addition of 120# sodium borate led to the similar results as the control because the borate spheres are not very stable in water, and thus show a small change using Sedigraph. In contrast, borate spheres show better properties in non-aqueous systems.

### Example 2

### Paint Formulations

The following 65% PVC paint formulations and 45% PVC paint formulations were prepared.

### 65% PVC Paint Formulation—100 Gallons:

| Components | Weight (pounds) |
|---|---|
| Water | 339.86 |
| KTPP | 1.76 |
| TAMOL 731 | 7.83 |
| IGEPAL CO-610 | 3.92 |
| COLLIDS 681F | 2.94 |
| TiO₂ (R-706) | 58.81 |
| Sample | 339.41 |
| NEOGEN 2000 | 148.43 |
| NATROSOL PLUS | 3.86 |
| UCAR379 | 213.47 |
| Ethylene glycol | 24.48 |
| TEXANOL | 9.79 |
| Water | 45.05 |

KTPP = potassium tripolyphophate
TAMOL 731 = surfactant or wetting agent commercially available from Rohm and Haas. Sodium salt of polycarboxylated condensed naphthalene.
IGEPAL CO-610 = commercially available from Stepan Company, Northfield, Illinois.
COLLIDS 681F = liquid defoamer available from Colloids, Inc.
TiO₂ (R-706) = rutile titanium oxide pigment commercially available from DuPont.
Coarse GCC = coarse ground calcium carbonate available from Imerys.
Median particle size (D50) = approximately 12-14 μm.
Fine GCC = finer ground calcium carbonate available from Imerys.
Median particle size (D50) = approximately 0.7 and 1 μm.
NEOGEN 2000 = calcined kaolin available from Imerys.
NATROSOL PLUS = hydrophobically modified hydroxyethylcellulose (HMHEC) available from Hercules, Inc., Wilmington, DE.
UCAR379 = thickener commercially available from Dow.
TEXANOL = ester alcohol based coalescent commercially available from Eastman Kodak. Chemical formula 2,2,4-trimethyl-1,3-pentanediol monoisobutyrate.

In the above formulation, all ingredients down to NATROSOL PLUS were added and then the mixture was ground to disperse the pigment. Once dispersed, the UCAR, Ethylene glycol, TEXANOL and the remaining water were mixed into the dispersion.

For the tinted color measurements, 11#/100 gal phthalo blue was admixed. The phthalo blue used was an 888 series phthalo blue available from Degussa Corp., Parsippany, N.J.

The sample listed in the 65% PVC paint formulation was prepared according to the procedure using the ground calcium carbonate as set forth in Example 1.

### 45% PVC Paint Formulation—100 Gallons:

| Components | Weight (pounds) |
|---|---|
| Water | 292.00 |
| KTPP | 1.80 |
| TAMOL 731 | 8.00 |
| IGEPAL CO-610 | 4.00 |
| COLLIDS 681F | 3.00 |
| TiO₂ (R-706) | 105.36 |
| Sample | 74.36 |
| NEOGEN 2000 | 205.46 |
| NATROSOL PLUS | 4.00 |
| UCAR 379 | 331.60 |
| Ethylene glycol | 25.00 |
| TEXANOL | 10.00 |
| Water | 46.00 |

The sample listed in the 45% PVC paint formulation was prepared according to the procedure using the ground calcium carbonate as set forth in Example 1.

### Example 3

### Optical Properties

The optical properties of the dry paint film including 60° Gloss, 85° Sheen, the color component values a, b, and L on the color space scale, opacity, and 457 brightness were also determined. Gloss and sheen were measured using a Hunter Pro-3 Gloss Meter. Color values (L, a, b) were measured using a Hunter Ultrascan XE.

The results obtained from the 65% PVC paint formulations are shown in Tables I and II below. The sample designated “Coarse GCC Control” is a coarse GCC having a nominal median particle size in the range of 12-14 μm that are commonly used to provide flatting in paints. The samples designated “Fine GCC” are made from a commercial fine GCC having a nominal median particle size of approximately 0.7 μm, and were prepared as indicated in the heading of the appropriate column.

TABLE I
65% PVC
Formulation

| | | Spray Dried | | | |
|---|---|---|---|---|---|
| | | Fine GCC | Spray Dried Fine | Spray Dried Fine | Spray Dried Fine GCC + |
| | Coarse GCC | Control-No | GCC + 52#/ton | GCC + 173#/ton | 100#/ton |
| | Control | Binder | NaSil Binder | NaSil Binder | H₂PO₄ Binder |
| 60° Gloss | 2.8 | 3.6 | 2.7 | 2.5 | 3.1 |
| 85° Sheen | 2.0 | 39.3 | 1.6 | 1.5 | 3.8 |
| Untinted | | | | | |
| L | 94.68 | 95.85 | 95.50 | 95.59 | 96.07 |
| a | −0.73 | −0.68 | −0.70 | −0.69 | −0.67 |
| b | 1.54 | 1.20 | 1.27 | 1.16 | 1.05 |
| Opacity (Y) | 94.53 | 97.80 | 97.34 | 98.01 | 98.24 |
| WI E313 (2/C) | 82.50 | 86.41 | 85.38 | 86.07 | 87.52 |
| YI E313 (2/C) | 2.45 | 1.80 | 1.93 | 1.72 | 1.52 |
| 457 Brightness | 87.93 | 90.57 | 89.81 | 90.13 | 91.19 |
| Tinted | | | | | |
| L | 73.71 | 78.86 | 77.27 | 78.90 | 79.92 |
| a | −10.93 | −9.56 | −10.17 | −9.77 | −9.33 |
| b | −23.35 | −18.90 | −20.32 | −18.88 | −18.07 |
| ΔE | 0.00 | 6.94 | 4.74 | 6.95 | 8.31 |
| ΔL | 0.00 | −5.15 | −3.56 | −5.19 | −6.21 |
| Δa | 0.00 | −1.37 | −0.76 | −1.16 | −1.60 |
| Δb | 0.00 | −4.45 | −3.03 | −4.47 | −5.28 |

All the delta values are relative to the control, which was a coarse GCC commonly used as a flatting agent. Aggregated samples were prepared using the indicated amounts of sodium silicate or H₂PO₄ binder.

As shown in Table I, the dry paint films of the inventive paint formulations had at least one improved property over the controls. Such properties include higher opacity for untinted formulations, higher tint strength for the tinted formulations or both.

TABLE II
65% PVC
Formulation

| | | Spray Dried Fine | Spray Dried Fine | Spray Dried Fine | Spray Dried Fine |
|---|---|---|---|---|---|
| | Coarse GCC | GCC + 100#/ton | GCC + 200#/ton | GCC + 100#/ton | GCC + 200#/ton |
| | Control | NaBorate | NaBorate | AM Borate | AM Borate |
| 60° Gloss | 3.1 | 3.2 | 6.9 | 3.3 | 3.3 |
| 85° Sheen | 4.8 | 15.5 | 2.0 | 25.7 | 11.9 |
| Untinted | | | | | |
| L | 95.51 | 96.11 | 95.34 | 96.24 | 96.15 |
| a | −0.76 | −0.72 | −0.72 | −0.70 | −0.70 |
| b | 1.41 | 1.14 | 1.40 | 1.15 | 1.18 |
| Opacity (Y) | 97.09 | 98.00 | 97.28 | 98.82 | 98.52 |
| WI E313 (2/C) | 84.75 | 87.18 | 84.44 | 87.40 | 87.08 |
| YI E313 (2/C) | 2.16 | 1.65 | 2.18 | 1.68 | 1.74 |
| 457 | 89.68 | 91.14 | 89.31 | 91.39 | 91.18 |
| Brightness | | | | | |
| Tinted | | | | | |
| L | 80.11 | 82.76 | 82.32 | 82.71 | 82.72 |
| a | −9.38 | −8.39 | −8.57 | −8.56 | −8.54 |
| b | −16.80 | −14.59 | −14.85 | −14.92 | −14.79 |
| ΔE | 0.00 | 3.59 | 3.06 | 3.31 | 3.40 |
| ΔL | 0.00 | −2.65 | −2.21 | −2.60 | −2.61 |
| Δa | 0.00 | −0.99 | −0.81 | −0.82 | −0.84 |
| Δb | 0.00 | −2.21 | −1.95 | −1.88 | −2.01 |

All the delta values are relative to the control, which was a coarse GCC commonly used as a flatting agent. Aggregated samples were prepared using the indicated amounts of sodium borate binder or ammonium borate binder.

As shown in Table II, the dry paint films of the inventive paint formulations had higher opacity for untinted formulations, and higher tint strength for the tinted formulations.

The results obtained from the 45% PVC paint formulations are shown in Table III below.

TABLE III
45% PVC
Formulation

| | | | | | Spray Dried | |
|---|---|---|---|---|---|---|
| | | | | Spray Dried | Fine GCC + | |
| | | | Spray Dried | Fine GCC + | 100#/ton | Spray Dried Fine |
| | Coarse GCC | Fine GCC | Fine GCC no | 52#/ton NaSil | Phosphoric Acid | GCC + 173#/ton |
| | Control | Control | binder | Binder | Binder | NaSil Binder |
| 60° Gloss | 3.0 | 3.1 | 3.1 | 2.9 | 3.0 | 2.9 |
| 85° Sheen | 7.2 | 19.0 | 19.8 | 3.5 | 6.4 | 3.4 |
| Untinted | | | | | | |
| L | 95.17 | 95.50 | 95.34 | 95.06 | 95.34 | 95.39 |
| a | −0.88 | −0.88 | −0.87 | −0.88 | −0.88 | −0.87 |
| b | 1.30 | 1.25 | 1.24 | 1.37 | 1.27 | 1.33 |
| Opacity (Y) | 95.52 | 96.42 | 96.78 | 96.55 | 96.73 | 96.80 |
| WI E313 (2/C) | 84.59 | 85.44 | 85.16 | 84.05 | 85.03 | 84.85 |
| YI E313 (2/C) | 1.85 | 1.77 | 1.76 | 2.00 | 1.81 | 1.93 |
| 457 Brightness | 89.25 | 89.93 | 89.63 | 88.95 | 89.59 | 89.61 |
| Tinted | | | | | | |
| L | 77.93 | 78.61 | 78.11 | 76.85 | 77.85 | 78.09 |
| a | −9.88 | −9.67 | −9.84 | −10.11 | −9.91 | −9.77 |
| b | −18.88 | −18.42 | −18.89 | −19.92 | −19.11 | −18.74 |
| ΔE | 0.00 | 0.85 | 0.18 | 1.52 | 0.25 | 0.24 |
| ΔL | 0.00 | −0.68 | −0.18 | 1.08 | 0.08 | −0.16 |
| Δa | 0.00 | −0.21 | −0.04 | 0.23 | 0.03 | −0.11 |
| Δb | 0.00 | −0.46 | 0.01 | 1.04 | 0.23 | −0.14 |

All the delta values are relative to the control, which was a coarse GCC commonly used as a flatting agent. Aggregated samples were prepared using the indicated amounts of sodium borate binder or phosphoric acid binder.

As shown in Table III, the dry paint films of the inventive paint formulations had higher opacity for untinted formulations and higher AE values for the tinted formulations than the control.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention.

Other embodiments of the invention will be apparent to those skilled in the art from consideration of the specification. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-47. (canceled)

48. A paint comprising at least one dry aggregated calcium carbonate, wherein the at least one dry aggregated calcium carbonate comprises calcium carbonate and at least one inorganic binder, wherein the dry aggregated calcium carbonate has a median aggregate particle size (D50) of at least 5 μm.

49. The paint according to claim 48, wherein the dry aggregated calcium carbonate has a median aggregate particle size (D50) of at least 10 μm.

50. The paint according to claim 48, wherein the dry aggregated calcium carbonate has a median aggregate particle size (D50) of at least 15 μm.

51. The paint according to claim 48, wherein the at least one inorganic binder is chosen from silicates, phosphates, borates, tungstates, other polyvalent metal salts, and boric acid.

52. The paint according to claim 48, wherein the at least one inorganic binder is chosen from alkali metal silicates.

53. The paint according to claim 48, wherein the at least one inorganic binder is phosphoric acid.

54. The paint according to claim 48, further comprising at least one additive chosen from pigments other than the aggregated calcium carbonate, surfactants, thickeners, defoamers, wetting agents, dispersants, solvents, and coalescents.

55. The paint according to claim 48, wherein the paint is chosen from textured paints, latex paints, oil-based paints, and acrylic paints.

56. The paint according to claim 48, wherein the paint has a pigment volume concentration ranging from 40% to 70%.

57. The paint according to claim 48, wherein the paint has a pigment volume concentration of at least 70%.

58. The paint according to claim 48, wherein the dry paint film made from the paint has a sheen of less than 8 and an opacity of at least 92.

59. The paint according to claim 48, wherein a dry paint film made from the paint has a PVC in the range of 40% to 50%.

60. The paint according to claim 48, wherein a dry paint film made from the paint has a sheen and an opacity of the following relationship:
Op≧(0.88s)+Y, wherein Op=opacity, s=sheen, and Y is an integer chosen from 92 to 95.

61. The paint according to claim 60, wherein the opacity is greater than 94 and the sheen is less than 3.

62. The paint according to claim 60, wherein the opacity is greater than 95 and the sheen is less than 4.

63. The paint according to claim 60, wherein the opacity is greater than 96 and the sheen is less than 5.

64. The paint according to claim 60, wherein the opacity is greater than 97 and the sheen is less than 6.

65. A paint, wherein the dry paint film made from the paint has a PVC in the range of from 40% to 50% and wherein the dry paint film also has a sheen and an opacity of the following relationship:
Op≧(0.88s)+Y, wherein Op=opacity, s=sheen, and Y is an integer chosen from 92 to 95.

66. The paint according to claim 65, wherein the opacity is greater than 94 and the sheen is less than 3.

67. The paint according to claim 65, wherein the opacity is greater than 96 and the sheen is less than 5.
